(19) United States
(12) Patent Application Publication
(10) Pub. No.: US 2014/0188716 A1
(43) Pub. Date: Jul. 3, 2014

(54) AUTOMATED FIRST PARTY DEBT COLLECTION SYSTEM

(71) Applicant: Volker Neuwirth, Eden, UT (US)

(72) Inventor: Volker Neuwirth, Eden, UT (US)

(21) Appl. No.: 13/731,871

(22) Filed: Dec. 31, 2012

(51) Int. Cl. G06Q 20/14

(52) U.S. Cl. CPC G06Q 20/14
USPC 705/40

(57) ABSTRACT

The present invention provides an automated first party debt collection system. The automated first party debt collection system provides a web based system that a company that is owed money can use to attempt to collect debts. Accordingly, the system can provide many of the benefits of a debt collection agency directly to a company without requiring the company to use and pay for the services of a debt collection agency.

### CROSS-REFERENCE TO RELATED APPLICATIONS

Not Applicable.

### BACKGROUND

When companies are owed money, they often resort to using debt collection agencies to recover some of the money they are owed. Although debt collection agencies are generally more efficient at recovering the debt, their use can be undesirable because of the large fees they charge. In particular, a company may not desire to request the assistance of a debt collection agency until it has become highly unlikely that the company will recover any of the debt by interacting directly with the debtor. In such cases, the company may not be concerned with the high percentage of the debt that the agency retains for their services as long as the company receives some portion of the debt.

To avoid paying high fees to debt collection agencies, some companies may employ individuals who are tasked with collecting debts. Although using in house debt collectors can be helpful for some companies, many companies do not have the resources or cannot justify the cost of doing so. Further, such individuals are generally not as effective as debt collection agencies.

### BRIEF SUMMARY

The present invention extends to methods, systems, and computer program products for providing an automated first party debt collection system. The automated first party debt collection system provides a web based system that a company that is owed money can use to attempt to collect debts. In other words, the system can provide many of the benefits of a debt collection agency directly to a company without requiring the company to use and pay for the services of a debt collection agency.

A company can submit debt information directly to the debt collection system (e.g. via a web page, an application, or directly from an accounting or record keeping software program that is integrated with the debt collection system). The debt collection system can automatically commence a campaign to collect the debt using any number of strategies that can be based on the type, amount, or importance of the debt, the likelihood of collecting the debt, or any other factor. In this manner, the company retains complete control over the debt, while also obtaining the benefits of having a system actively and automatically attempt to collect on the debts.

In one embodiment, information regarding a debt owed to an entity is received from a client computing system. The information includes an identification of the debtor, contact information of the debtor, and an amount of the debt. A classification for the debt is determined. A strategy for recovering the amount of the debt from the debtor is also determined. Based on the determined classification and strategy of the debt with respect to a determined classification and strategy of other debts, a campaign is commenced to collect the amount of the debt. The campaign includes contacting the debtor to offer the debtor the opportunity to make a payment to satisfy the debt. Finally, a payment is received from the debtor that partially or wholly satisfies the debt.

This summary is provided to introduce a selection of concepts in a simplified form that are further described below in the Detailed Description. This Summary is not intended to identify key features or essential features of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary computing environment in which the present invention can be implemented;

FIGS. 2A-2C illustrate the content of an exemplary user interface for interacting with a debt collection system in accordance with one or more embodiments of the invention;

FIG. 3 illustrates how a debtor can be contacted in response to a company submitting a debt to the debt collection system of the present invention; and

FIG. 4 illustrates a flowchart of an exemplary method for providing an automated first party debt collection service.

### DETAILED DESCRIPTION

The present invention extends to methods, systems, and computer program products for providing an automated first party debt collection system. The automated first party debt collection system provides a web based system that a company that is owed money can use to attempt to collect debts. In other words, the system can provide many of the benefits of a debt collection agency directly to a company without requiring the company to use and pay for the services of a debt collection agency.

A company can submit debt information directly to the debt collection system (e.g. via a web page, an application, or directly from an accounting or record keeping software program that is integrated with the debt collection system). The debt collection system can automatically commence a campaign to collect the debt using any number of strategies that can be based on the type, amount, or importance of the debt, the likelihood of collecting the debt, or any other factor. In this manner, the company retains complete control over the debt, while also obtaining the benefits of having a system actively and automatically attempt to collect on the debts.

In one embodiment, information regarding a debt owed to an entity is received from a client computing system. The information includes an identification of the debtor, contact information of the debtor, and an amount of the debt. A classification for the debt is determined. A strategy for recovering the amount of the debt from the debtor is also determined. Based on the determined classification and strategy of the debt with respect to a determined classification and strategy of other debts, a campaign is commenced to collect the amount of the debt. The campaign includes contacting the debtor to offer the debtor the opportunity to make a payment to satisfy the debt. Finally, a payment is received from the debtor that partially or wholly satisfies the debt.

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

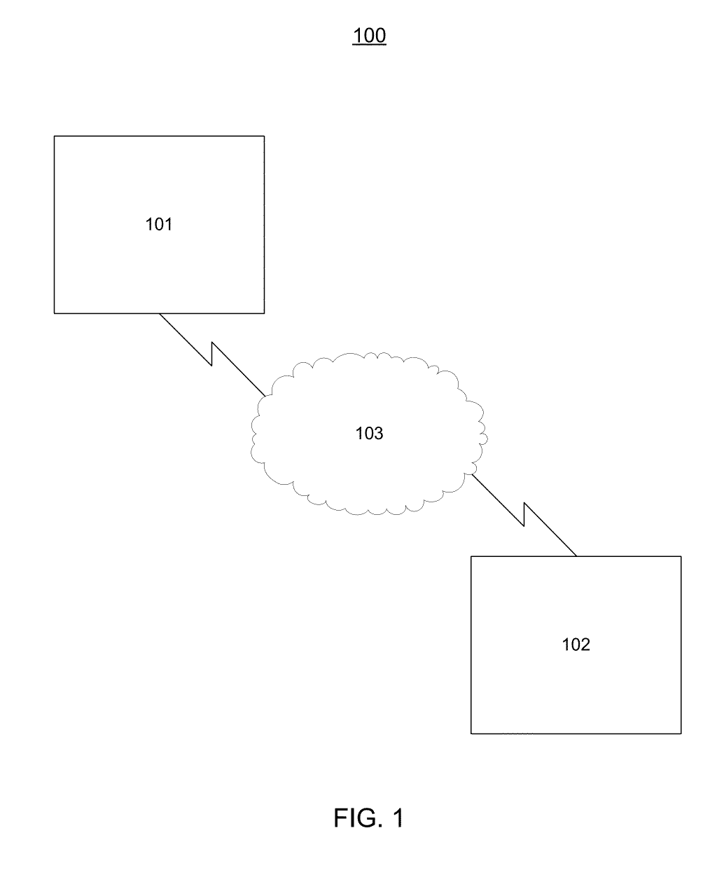

FIG. 1 illustrates an exemplary computer environment 100 in which the present invention can be implemented. Computer environment 100 includes server system 101 and client system 102 that are interconnected via a network 103 (e.g. the internet).

Server system 101 represents the system that hosts the automated first party debt collection system of the present invention. Server system 101 can represent any number or type of computing devices or components including a single server or a cloud of interconnected computing components.

Client system 102 represents the system used by a client to access the automated first party debt collection system. Client system 102 can also be any type or number of computing devices or components. In a typical example, client system 102 can be a desktop computer, a laptop computer, a tablet, a mobile phone, or other mobile device having internet access.

Server system 101 provides a web accessible interface to allow client system 102 to access the debt collection system. For example, the interface can comprise a web page, a dedicated application including a mobile application, a plug-in for another application, or other similar interface. A user, such as an employee of a company that is owed money, can access the debt collection system via client system 102 as is further described below.

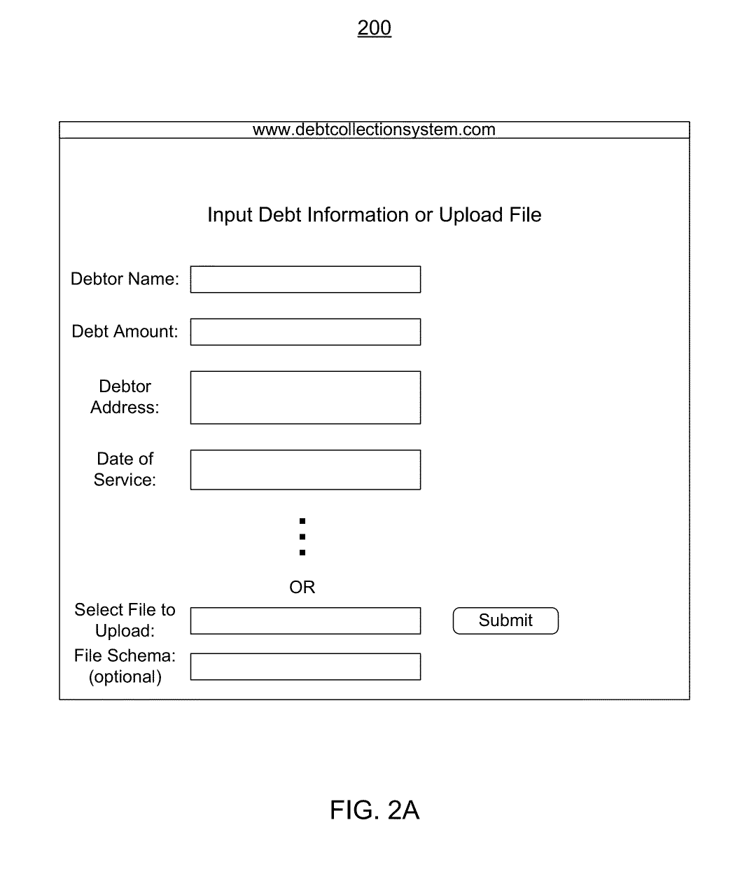

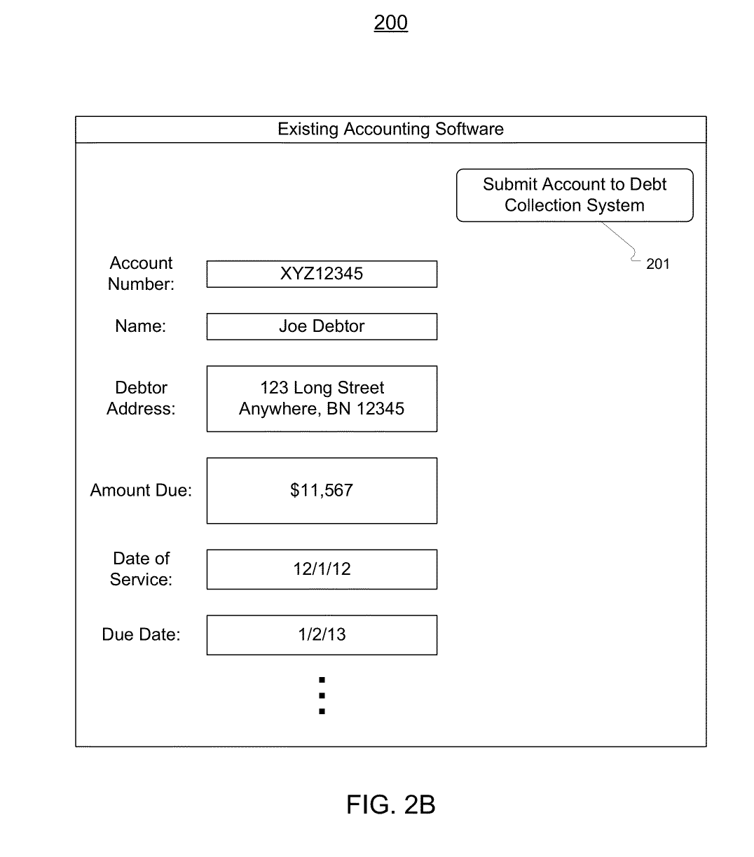

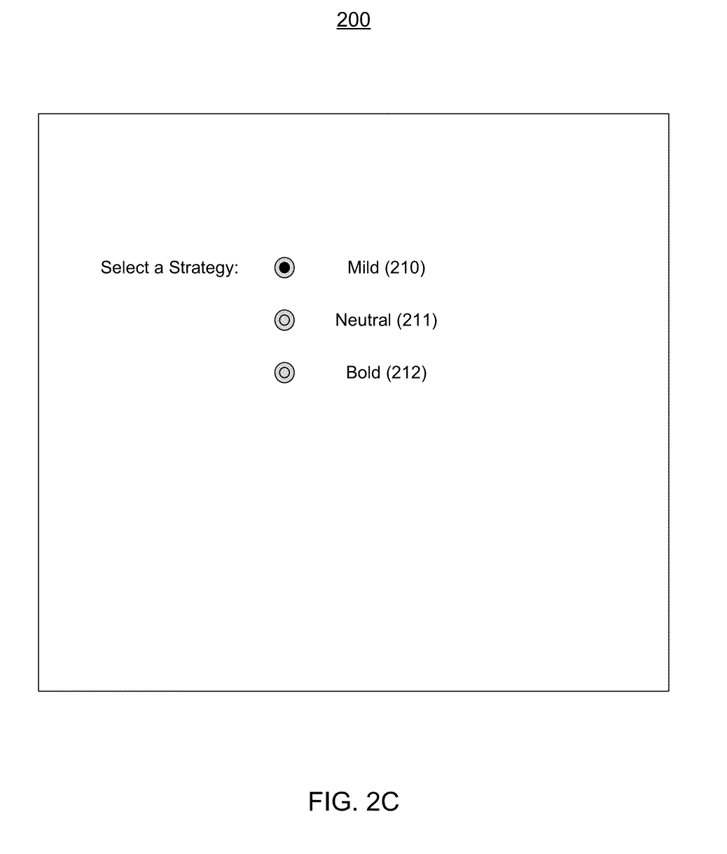

FIG. 2A illustrates an exemplary user interface 200 that allows a user to input debt information to the debt collection system. User interface 200 is in the form of a web page that allows a user to upload accounts. An account can be uploaded in various ways. For example, an account can be manually created such as by inputting the required information into fields in user interface 200. Similarly, an account can be uploaded as a file that contains the required information (e.g. a spreadsheet, CSV file, etc.). In such embodiments, the debt collection system can be configured to accept information formatted according to one or more schemas.

In other embodiments, a user interface can be provided that acts as a plug-in for an existing accounting or billing system software program. For example, as shown in FIG. 2B, if a company uses a particular accounting program to track account receivables, user interface 200 can be in the form of a button (e.g. button 201), link, or other executable object in the user interface of the accounting software that allows an account to be automatically submitted to the debt collection software. In other words, a user of the accounting software, when viewing a particular account, can select a button that will automatically submit the required information of the account being viewed to the debt collection software of the present invention.

Similarly, the user interface of the accounting software can be configured to allow a batch submission of accounts. For example, the user interface can allow a user to select to submit all accounts having a past due balance, all accounts that are a specified number of days overdue, a selected number of accounts, etc.

In short, the particular design of a user interface by which information is submitted to the debt collection system is not essential to the present invention. Any interface that allows the required information about a debt to be input can be used. This required information can include the identity of the debtor, contact information about the debtor, the amount of the debt, and the date of service from which the debt arose (i.e. the age of the debt). Other information may also be provided such as the product or service for which the debt was acquired, a social security number of the debtor, the debtor's birthdate, or additional contact information.

Virtually any type of contact information can be employed by the debt collection system of the present invention. For example, the debtor's physical address, telephone number, email address, social media identifier (e.g. a Facebook, LinkedIn, or Twitter username), instant messaging address, etc. could be submitted to or stored by the debt collection system. As new social media platforms or other contact methods are developed or popularized, such platforms or methods could also be used.

Also, in some embodiments, the date of service for which the debt arose can be a required field when submitting a debt to the system. The date of service can be used in determining the likelihood of recovering the debt, an amount to charge to attempt to collect the debt, etc.

As shown in FIG. 2C, user interface 200 can also allow the user to select the type of strategy to be used in attempting to collect the debt. For example, user interface 200 can provide preconfigured strategies of Mild 210, Neutral 211, and Bold 212. Each of these preconfigured strategies can include a different set of approaches that will be used to collect a debt. By selecting a preconfigured strategy, the user can be relieved of deciding each individual approach that will be used. Alternatively, user interface 200 can provide an option for the user to custom select each approach that will be used.

Examples of approaches that can be used include: standard or custom emails, voice calls or messages, SMS texts, social media communications, instant messages, etc. as well as the timing and frequency of such communications. A particular strategy can combine one or more of the available approaches. User interface 200 can also provide an option for defining how long the debt collection system should attempt to collect the debt (e.g. 30 days, 60 days, 90 days, etc.). The selection of a strategy can be performed each time a debt is submitted, once for all debt submissions, or at any other interval.

Once a debt has been submitted and the approach defined (whether at the time of submission of the debt or previously), the debt collection system can generate a collection score that is used in determining how to classify a debt. In some embodiments, the collection score can be obtained from, or based on information provided by, a collection score provider (e.g. Experian, Transunion, etc.).

Debts can be classified into various classifications. For example, in some embodiments, classifications of Qualified, Mid-Qualified, and Non-Qualified can be used. In such cases, debts having a higher collection score can be assigned to the Qualified classification, debts with a mid-range collection score can be assigned to the Mid-Qualified classification, and debts with a low collection score can be assigned to the Non-Qualified classification.

Additional criteria can also be used to determine how a debt is classified. For example, in addition to collection score, criteria such as the specified strategy (e.g. Mild, Neutral, Bold), location (e.g. to determine legal approaches given the debtor's or creditor's location), age of the debt, debtor age, available communication means, debt amount, type of service or product for which debt arose, historical data for collecting debt from debtor, etc. can be used. The debt collection system can use any combination of such criteria to determine which debts are most likely to be collected and classify the debts accordingly.

In this manner, the debt collection system, rather than the end user, can select the best approach for recovering a debt thereby relieving the user from much of the burden of collecting debt. Specifically, because the debt collection system can track the effectiveness of certain strategies with respect to certain debtors or debtor characteristics, the debt collection system can dynamically determine a most appropriate approach for collecting a particular debt.

The debt collection system can also provide an error management service for detecting when erroneous information has been provided. For example, the error management service can detect that bad contact information has been provided and inform the user accordingly so that the user can attempt to correct the information. This determination can be made initially when the information is provided (e.g. by checking the information against a database of known good information) or in response to failed attempts to contact a debtor.

For example, when a debtor is contacted, the message provided can include an option to inform the service that the person contacted is not associated with the debt. In a particular example, an email or text message can include a link that the recipient can click to inform the service that the email has been sent to the wrong person. The system can also detect that bad information is being used such as by receiving an email bounce message, a disconnected phone number, etc.

Depending on the above described factors, the debt collection system can commence contacting the debtor to attempt to recover the debt. For example, the debt collection system can make an automated phone call that informs the debtor of the debt and provides the option to make a payment via a voice prompt system, to input a phone number to receive a text with a link to a web based payment form, or to be linked back to the company to which the debt is owed. In such cases, if the debtor inputs a phone number, the phone number can be saved into the debt collection system for use in collecting debts from the debtor in the future.

With respect to the error management service, the automated phone call can provide a way for the contacted person to verify that he is not the debtor. For example, the automated phone call can prompt the contacted person to answer how long he has used the phone number, and to provide any other information to assist in determining whether the contacted person is not the debtor. When this occurs, the debt collection system can prevent future communications from being made regarding the associated debt until it can be determined whether the debtor's information is incorrect. In some embodiments, the debt collection system can route the disputed information back to the user to allow the user to determine whether there is an error, or the debt collection system can attempt to verify the information itself.

In cases when the debt collection system has an email address of a debtor, an email can be sent to inform or remind the debtor of the debt. The email can provide a link for providing a web based payment, or a number that the debtor can call to make a payment over the phone. Similarly, the email can provide a way for the recipient to inform the debt collection system that the email was sent to the wrong person.

In cases when the debt collection system has a cell phone number of a debtor, a text message can be sent. The text message can contain similar information as the email described above. Similar approaches can be taken when a debtor's social media username or other similar contact information is known. Finally, if no contact information, other than an address, has been provided, a letter can be sent with the appropriate information.

The debt collection system can provide various payment options for the debtor. For example, when the debtor clicks a link in an email or text, a web page can be opened that allows the debtor to input credit card, ACH, PayPal, Pay via Google, Pay via Amazon, or other payment information. The payment options can also include an option to make recurring payments.

In some embodiments, the debt collection system can provide an automated settlement system that is configured to determine an amount to offer the debtor to settle the debt. The amount to offer can be determined based on various factors including the age and amount of the debt. If the debtor accepts the offer, payment of the amount can be accepted along with a signature of the debtor to confirm the agreement. The signature can be obtained in accordance with the techniques disclosed is commonly-owned U.S. Provisional Patent Application No. 61/700,250.

The debt collection system of the present invention can also provide a dashboard listing various types of information regarding debts being managed for the user. For example, the dashboard can list how long each debt has been with the system, how many debts are in each classification (e.g. Qualified, Mid-Qualified, and Non-Qualified), how many attempts have been made to contact the debtor, the status of recurring payments, the status of settled debts, the amount of debt collected over a period of time, the total amount of debt collected, the average time before a payment is received on a debt, etc. Any or all of the information provided on the dashboard can be made available to download to the company's own accounting or other record keeping system.

In some embodiments, debts can be organized into batches. For example, the user can specify a batch into which a debt should be grouped, or a batch may be defined as all debts within a particular upload (e.g. each debt listed in an uploaded file). In such cases, the dashboard can also provide statistics regarding each batch.

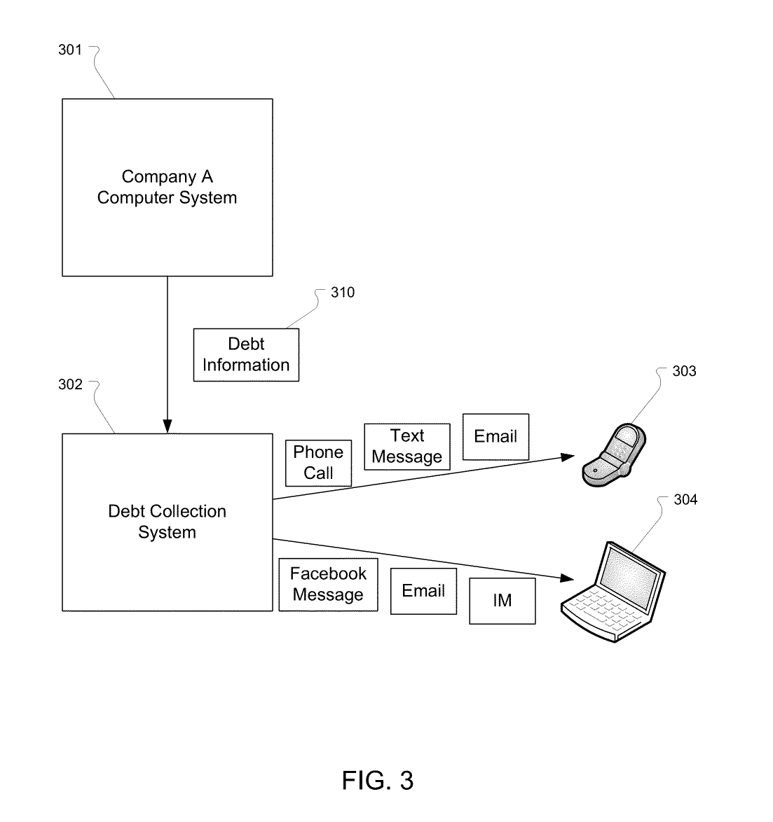

FIG. 3 illustrates an exemplary scenario of how the debt collection system of the present invention could be employed by a company to facilitate the collection of debt. If a company A is owed an amount by debtor B, company A, via computer system 301, can access the debt collection system provided by computer system 302 to provide information 310 about debtor B. Company A can also specify that it wants to be aggressive in collecting the debt (e.g. by selecting Bold as the strategy to employ).

In response, the debt collection system can identify contact information of debtor B (whether supplied by company A or previously obtained by the system). Based on the type of contact information, the system commences contacting debtor B (via cell phone 303 and/or laptop 304) to offer debtor B the opportunity to satisfy the debt by paying the amount due. The communication can be a phone call that includes an option to access a phone based payment system, an email, text, or social media communication containing a link to a web page for entering payment information, etc.

After a payment is received by the system, the amount can be transferred to company A. The debt payment system can analyze the approach used to collect the debt from debtor B to optimize future attempts to collect debt from debtor B or from other debtors.

In this manner, company A is able to collect the debt without having to employ a third party debt collection agency, or having to invest in employing an in-house debt collector. Further, because the debt collection system can be integrated with company A's existing accounting software or accessed using standard web-based interfaces, little or no training is required to begin using the debt collection system.

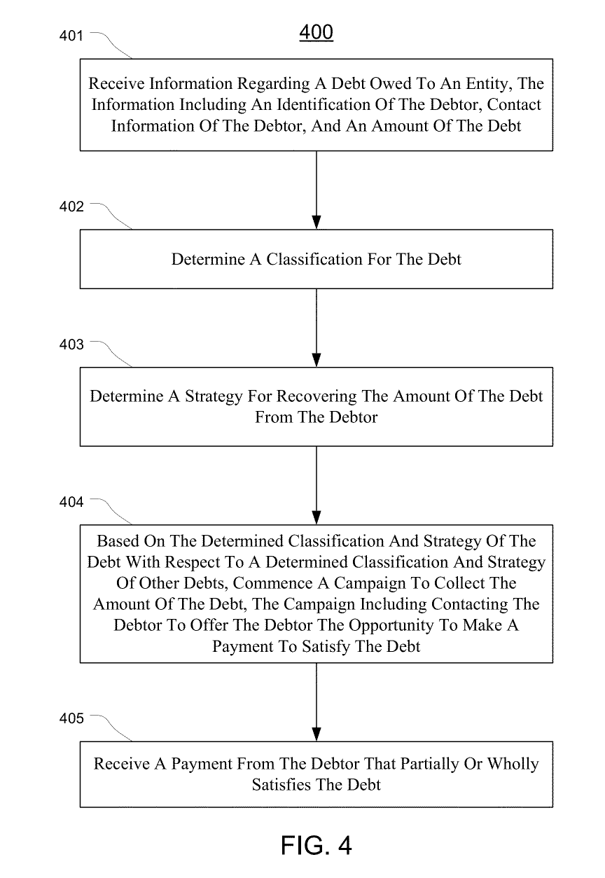

FIG. 4 illustrates a flowchart of an exemplary method 400 for providing an automated first party debt collection service. Method 400 can be implemented by a computer system such as computer system 102 or 302.

Method 400 includes an act 401 of receiving information regarding a debt owed to an entity, the information including an identification of the debtor, contact information of the debtor, and an amount of the debt. For example, computer system 302 can receive debt information 310 from computer system 301.

Method 400 includes an act 402 of determining a classification for the debt. For example, debt information 310 can be evaluated to identify a classification for the debt (e.g. qualified, mid-qualified, or non-qualified).

Method 400 includes an act 403 of determining a strategy for recovering the amount of the debt from the debtor. For example, various communication methods can be identified for contacting the debtor, an appropriate time and frequency for contacting the debtor can be determined, etc.

Method 400 includes an act 404 of based on the determined classification and strategy of the debt with respect to a determined classification and strategy of other debts, commencing a campaign to collect the amount of the debt, the campaign including contacting the debtor to offer the debtor the opportunity to make a payment to satisfy the debt. For example, computer system 302 can commence contacting the debtor via one or more communication methods.

Method 400 includes an act 405 of receiving a payment from the debtor that partially or wholly satisfies the debt. For example, computer system 302 can receive a payment from the debtor to pays off all or a portion of the debt.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by a server computing system, for providing an automated first party debt collection service, the method comprising:
receiving, from a client computing system, information regarding a debt owed to an entity, the information including an identification of the debtor, contact information of the debtor, and an amount of the debt;
determining a classification for the debt;
determining a strategy for recovering the amount of the debt from the debtor;
based on the determined classification and strategy of the debt with respect to a determined classification and strategy of other debts, commencing a campaign to collect the amount of the debt, the campaign including contacting the debtor to offer the debtor the opportunity to make a payment to satisfy the debt; and
receiving a payment from the debtor that partially or wholly satisfies the debt.

2. The method of claim 1, wherein the classification is determined based on a collection score of the debtor.

3. The method of claim 1, wherein the strategy is specified in the information received from the client computing system.

4. The method of claim 3, wherein the strategy defines the types and frequency of communications to be used to contact the debtor.

5. The method of claim 4, wherein the types of communications include one or more of: phone calls, emails, text messages, instant messages, social media communications, or letters.

6. The method of claim 1, wherein contacting the debtor comprises calling the debtor and providing an option to the debtor to select to provide payment over the phone.

7. The method of claim 1, wherein contacting the debtor comprises calling the debtor and providing an option to the debtor to input a cell phone number at which a text message can be sent to provide a link to make a web-based payment.

8. The method of claim 1, wherein contacting the debtor comprises emailing the debtor, the email containing a link to make a web-based payment.

9. The method of claim 1, wherein contacting the debtor comprises texting the debtor, the text message containing a link to make a web-based payment.

10. The method of claim 1, wherein offering the debtor the opportunity to make a payment to satisfy the debt comprises:
making a settlement offer to settle the debt for less than the amount of the debt; or
presenting an option to setup automatic recurring payments to satisfy the debt over a period of time.

11. The method of claim 10, further comprising:
providing an option to supply a signature on a mobile device to confirm the acceptance of the settlement offer.

12. The method of claim 1, further comprising:
providing an option to the debtor to indicate that the debtor is not associated with the debt.

13. The method of claim 1, wherein the information is received from an accounting system executed by the client computing system.

14. The method of claim 1, wherein the information is received in a file that is formatted according to a schema understood by the server computing system.

15. The method of claim 1, further comprising:
displaying a dashboard that provides statistics regarding debts that the server computing system has attempted to collect for the entity.

16. The method of claim 15, wherein the statistics include: how long a debt has been with the system, how much money has been collected by the system for the entity, how many debts the entity has with the system, a ratio of how much money has been collected by the system for the entity over a specified amount of time, or how many attempts have been made to collect a debt.

17. The method of claim 1, wherein the strategy is determined based on one or more of: a collection score of the debtor, a location of the debtor, the age of the debt, the age of the debtor, the type of contact information for the debtor, the amount of the debt, or the type of product or service for which the debt was assumed.

18. The method of claim 1, further comprising:
maintaining criteria for determining a strategy for a particular debt; and
updating the criteria based on attempts to collect other debts.

19. A system comprising:
one or more processors; and
memory storing computer executable instructions which when executed by any of the one or more processors implements a method for providing an automated first party debt collection service, the method comprising:
receiving, from a client computing system, information regarding a debt owed to an entity, the information including an identification of the debtor, contact information of the debtor, an amount of the debt, and an age of the debt;
determining a classification for the debt based at least partially on the age of the debt;
determining a strategy for recovering the amount of the debt from the debtor;
based on the determined classification and strategy of the debt with respect to a determined classification and strategy of other debts, commencing a campaign to collect the amount of the debt, the campaign including contacting the debtor to offer the debtor the opportunity to make a payment to satisfy the debt; and
receiving a payment from the debtor that partially or wholly satisfies the debt.

20. The system of claim 19, wherein contacting the debtor comprises:
sending multiple communications via multiple communication methods, each communication providing an option to automatically make a payment to satisfy the debt.
